(19) United States
(12) Patent Application Publication
(10) Pub. No.: US 2025/0132720 A1
(43) Pub. Date: Apr. 24, 2025

(54) DETERMINATION OF PARAMETERS FOR SET UP OF FIXED BRIDGES FOR PHOTOVOLTAIC POWER PLANTS

(71) Applicant: ACWA POWER Company, Riyadh (SA)

(72) Inventor: Omer SAROOD, Sydney (AU)

(21) Appl. No.: 18/924,755

(22) Filed: Oct. 23, 2024

Related U.S. Application Data
(60) Provisional application No. 63/592,462, filed on Oct. 23, 2023.

(51) Int. Cl. H02S 30/10

(52) U.S. Cl. CPC H02S 30/10

(57) ABSTRACT

A system and method for determination of parameters for the set up of fixed bridges for photovoltaic power plants. The system obtains user input comprising a first set of parameters associated with a fixed bridge from a user device. Further, the system determines a second set of parameters associated with the fixed bridge based on the first set of parameters. Furthermore, the system renders the determined second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

### CROSS-REFERENCE TO RELATED APPLICATION

This application claims priority to U.S. Provisional Patent Application Ser. No. 63/592,462, filed Oct. 23, 2023 and entitled AUTOMATIC ROBOTIC CLEANING SYSTEM FOR SOLAR PANELS, the disclosure which is incorporated herein by reference.

### TECHNOLOGICAL FIELD

The disclosure relates to the determination of parameters for the set up of fixed bridges for photovoltaic power plants, and more particularly relates to a system and a method for the determination of parameters for the set up of fixed bridges for photovoltaic power plants.

### BACKGROUND

Solar panels, also known as photovoltaic panels, are devices that convert sunlight into electricity through the photovoltaic effect. These solar panels include multiple solar cells made of semiconductor materials, typically silicon, which absorb photons from sunlight and release electrons, thereby generating an electric current. Recently, solar panels have gained widespread popularity as a sustainable and renewable energy source offering clean energy generation with minimal environmental impact. They are being used in various applications, from residential rooftop installations to large-scale solar farms, contributing to a global transition towards greener and more environmentally friendly energy sources. However, with usage over a long time, dust, dirt, and other debris accumulate on the surface of the solar panels and block the sunlight thereby, reducing the power generation through solar panels. Therefore, regular cleaning of the solar panels is necessary to maintain optimal efficiency in areas where a loss in generation due to the soiling of panels/modules is significant enough.

For cleaning the solar panels, automatic cleaning robots are used in the solar panel cleaning process. The automatic cleaning robots need to traverse between the solar panels to clean the solar panels. Traditionally, the connection system between the solar panels is often a complex, multi-component framework that may be costly and require labor-intensive work to install the connection system. The connection system often requires specific adjustments to ensure the alignment between the solar panels. This adjustment process results in an increased installation time and higher labor costs.

Furthermore, the complexity of the connection system may complicate the routine maintenance and cleaning operations. The presence of such complex connection systems may pose challenges in the alignment and stability of the solar panels leading to a reduced energy output of the solar panels. The prior available connection systems for the solar panels impose a challenge for the structural connectivity for the solar panels leading to a reduced energy output of the solar panels.

Therefore, an improved system for the determination of parameters for the set up of fixed bridges for photovoltaic power plants is needed for the effective connection of the solar panels in the photovoltaic power plants.

### BRIEF SUMMARY

In order to solve the foregoing problem, the present disclosure may provide a system, a method, and a computer program product for the determination of parameters for the setup of fixed bridges for photovoltaic power plants.

In one aspect, a system for the determination of parameters for the set up of fixed bridges for photovoltaic power plants is disclosed. The system includes a processor configured to obtain a user input including a first set of parameters associated with a fixed bridge from a user device. The fixed bridge is an inflexible coupling between a first solar panel of a set of solar panels and a second solar panel of the set of solar panels of a photovoltaic (PV) power plant. The set of solar panels is associated with a tracker. The processor is further configured to determine a second set of parameters associated with the fixed bridge based on the first set of parameters. The processor is further configured to render the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

In additional system embodiments, the processor is further configured to determine a set of instructions for the installation of the fixed bridge based on the second set of parameters. The set of instructions is associated with the installation of the fixed bridge between the first solar panel and the second solar panel. The processor is further configured to transmit the set of instructions to an installation device.

In additional system embodiments, the processor is further configured to determine a set of navigation instructions for the electronic device based on the second set of parameters. The set of navigation instructions is associated with cleaning of the set of solar panels of the PV power plant. The processor is further configured to transmit the set of navigation instructions to the electronic device. The processor is further configured to control the electronic device based on the set of navigation instructions.

In additional system embodiments, the set of navigation instructions includes a first navigation instruction to control the electronic device to navigate through the fixed bridge.

In additional system embodiments, the electronic device includes at least one of a track-based robot, a crawler robot, a drone-based robot, a water-based robot, a dry dust removal robot, a modular cleaning robot, an automated scrubber robot, or a vacuum cleaner robot.

In additional system embodiments, the second set of parameters is determined using an application of one or more mathematical operations on the first set of parameters.

In additional system embodiments, the first set of parameters includes a first parameter indicative of the gap between the module edge of the first solar panel and the module edge of the second solar panel, a second parameter indicative of a maximum design ground slope of a terrain on which the PV power plant is installed, a third parameter indicative of a maximum vertical offset of axially adjacent module edges, a fourth parameter indicative of a maximum horizontal offset of the axially adjacent module edges, and a fifth parameter indicative of a maximum magnitude of total angular misalignment between the module edge of the first solar panel and the module edge of the second solar panel.

In additional system embodiments, the axially adjacent module edges are indicative of a first module edge and a second module edge axially adjacent and aligned along a first axis. The first module edge is associated with the first solar panel and the second module edge is associated with the second solar panel.

In another aspect, a method for the determination of parameters for the setup of fixed bridges for photovoltaic power plants is disclosed. The method includes obtaining user input including a first set of parameters associated with a fixed bridge from a user device. The fixed bridge is an inflexible coupling between a first solar panel of a set of solar panels and a second solar panel of the set of solar panels of a photovoltaic (PV) power plant. The set of solar panels is associated with a tracker. The method further includes determining a second set of parameters associated with the fixed bridge based on the first set of parameters. The method further includes rendering the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

In additional methods, the method further includes determining a set of instructions for the installation of the fixed bridge based on the second set of parameters. The set of instructions is associated with the installation of the fixed bridge between the first solar panel and the second solar panel. The method further includes transmitting the set of instructions to an installation device.

In additional methods, the method further includes determining a set of navigation instructions for the electronic device based on the second set of parameters. The set of navigation instructions is associated with cleaning of the set of solar panels of the PV power plant. The method further includes transmitting the set of navigation instructions to the electronic device. The method further includes controlling the electronic device based on the set of navigation instructions.

In additional methods, the set of navigation instructions includes a first navigation instruction to control the electronic device to navigate through the fixed bridge.

In additional methods, the electronic device includes at least one of a track-based robot, a crawler robot, a drone-based robot, a water-based robot, a dry dust removal robot, a modular cleaning robot, an automated scrubber robot, or a vacuum cleaner robot.

In additional methods, the second set of parameters is determined using an application of one or more mathematical operations on the first set of parameters.

In additional methods, the first set of parameters includes a first parameter indicative of the gap between the module edge of the first solar panel and the module edge of the second solar panel, a second parameter indicative of a maximum design ground slope of a terrain on which the PV power plant is installed, a third parameter indicative of a maximum vertical offset of axially adjacent module edges, a fourth parameter indicative of a maximum horizontal offset of the axially adjacent module edges, and a fifth parameter indicative of a maximum magnitude of total angular misalignment between the module edge of the first solar panel and the module edge of the second solar panel.

In additional methods, the axially adjacent module edges are indicative of a first module edge and a second module edge axially adjacent and aligned along a first axis. The first module edge is associated with the first solar panel and the second module edge is associated with the second solar panel.

In yet another aspect, a non-transitory computer-readable storage medium having computer program code instructions stored therein, the computer program code instructions, when executed by a processor, cause the processor to obtain a user input including a first set of parameters associated with a fixed bridge from a user device. The fixed bridge is an inflexible coupling between a first solar panel of a set of solar panels and a second solar panel of the set of solar panels of a photovoltaic (PV) power plant. The set of solar panels is associated with a tracker. The computer program code instructions, when executed by a processor, cause the processor to determine a second set of parameters associated with the fixed bridge based on the first set of parameters. The computer program code instructions, when executed by a processor, cause the processor to render the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

In additional computer program product embodiments, the computer program code instructions, when executed by a processor, further cause the processor to determine a set of instructions for the installation of the fixed bridge based on the second set of parameters. The set of instructions is associated with the installation of the fixed bridge between the first solar panel and the second solar panel. The computer program code instructions, when executed by a processor, further cause the processor to transmit the set of instructions to an installation device.

In additional computer program product embodiments, the computer program code instructions, when executed by a processor, further cause the processor to determine a set of navigation instructions for the electronic device based on the second set of parameters. The set of navigation instructions is associated with cleaning of the set of solar panels of the PV power plant. The computer program code instructions, when executed by a processor, further cause the processor to transmit the set of navigation instructions to the electronic device. The computer program code instructions, when executed by a processor, further cause the processor to control the electronic device based on the set of navigation instructions.

In additional computer program product embodiments, the set of navigation instructions includes a first navigation instruction to control the electronic device to navigate through the fixed bridge.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the disclosure in general terms, reference will now be made to the accompanying drawings, which are not necessarily drawn to scale, and wherein:

FIG. 1 illustrates an environment for the determination of parameters for the set up of fixed bridges for photovoltaic power plants, in accordance with an embodiment of the disclosure;

FIG. 2 illustrates a block diagram of the system of FIG. 1, in accordance with an embodiment of the disclosure;

FIG. 3 illustrates exemplary operations for the determination of parameters for the set up of fixed bridges for photovoltaic power plants, in accordance with an embodiment of the disclosure;

FIG. 4 is a diagram that illustrates a first set of parameters and a second set of parameters, in accordance with an embodiment of the disclosure;

FIGS. 5A and 5B are exemplary diagrams that illustrate the second set of parameters associated with the fixed bridge, in accordance with an embodiment of the disclosure; and

FIG. 6 illustrates a method flowchart for the determination of parameters for the set up of fixed bridges for photovoltaic power plants, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

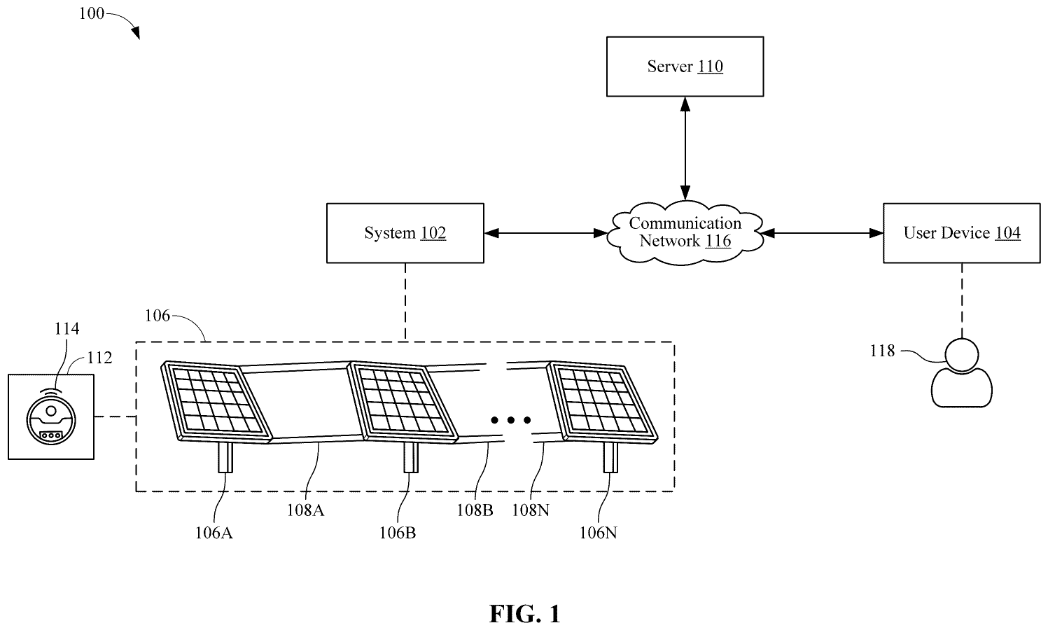

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of a determination of parameters for the set up of fixed bridges for photovoltaic power plants.

FIG. 1 illustrates an environment for a fixed bridge installation for solar panels, in accordance with an embodiment of the disclosure. With reference to FIG. 1, there is a shown network environment 100. The network environment 100 may include a system 102, a user device 104, a photovoltaic (PV) power plant 106, a set of solar panels (such as a first solar panel 106A, a second solar panel 106B up to an Nth solar panel 106N, a first fixed bridge 108A, a second fixed bridge 108B, up to an Nth fixed bridge 108N, a server 110, a docking station 112, an electronic device 114, a communication network 116, and a user 118.

The system 102 may include suitable logic, circuitry, interfaces, and/or code that may be configured to determine a set of parameters associated with the fixed bridge installation in the PV power plant 106. In an embodiment, the system 102 may be configured to obtain user input including a first set of parameters associated with the first fixed bridge 108A from the user device 104. The first fixed bridge 108A may be an inflexible coupling between the first solar panel 106A of the set of solar panels and the second solar panel 106B of the set of solar panels of the photovoltaic (PV) power plant 106. The set of solar panels may be associated with a tracker. The tracker tracks the movement of the sun on one axis. The system 102 may be configured to determine a second set of parameters associated with the first fixed bridge 108A based on the first set of parameters. The system 102 may be configured to render the determined second set of parameters including a first parameter indicative of the magnitude of a gap between a module edge of the first solar panel 106A and a module edge of the second solar panel 106B, a second parameter indicative of the magnitude of a slope angle across the first fixed bridge 108A, a third parameter indicative of the magnitude of a maximum angular difference between two sides of the first fixed bridge 108A, and a fourth parameter indicative of the width of a flat surface associated with a fail-safe location of the electronic device 114. Examples of the system 102 may include, but are not limited to, a computing device, a mainframe machine, a server, a computer workstation, a smartphone, a cellular phone, a mobile phone, a gaming device, and/or a consumer electronic (CE) device.

The user device 104 may include suitable logic, circuitry, interfaces, and/or code that may be configured to provide the user input to the system 102. The user input may include the first set of parameters associated with the first fixed bridge 108A. The user device 104 may be further configured to receive and render the second set of parameters on a display screen associated with the user device 104. Examples of the user device 104 may include, but are not limited to, a computing device, a mainframe machine, a server, a computer workstation, a smartphone, a cellular phone, a mobile phone, a gaming device, and/or a consumer electronic (CE) device.

In an embodiment, the user device 104 may be associated with the user 118. The user 118 may be an individual interacting with the system 102. In another embodiment, the user 118 may be an operator or an administrator responsible for configuring, controlling, or monitoring the PV power plant 106. The role of the user 118 may include tasks such as inputting parameters, initiating processes, or adjusting settings in the PV power plant 106 based on an output generated by the system 102, and the like.

The PV power plant 106 (also referred to as a solar power plant or solar farm or solar plant), may be a large-scale installation designed to generate electricity from sunlight using an array of solar panels (or solar arrays). Each array of solar panels (also referred to as the set of solar panels) may include one or more solar panels such as the first solar panel 106A, the second solar panel 106B, up to the Nth solar panel 106N. Each solar panel in the PV power plant 106 may be made of a semiconductor material like silicon that may convert sunlight into direct current (DC) electricity when exposed to sunlight. The generated electricity may be further converted into alternating current (AC) using one or more inverters and fed into an electrical grid or used for on-site consumption. The PV power plant 106 may vary in size from small installations on rooftops to vast utility-scale facilities covering extensive land areas, with the latter capable of producing megawatts or even gigawatts of electricity.

Each solar panel (also known as a photovoltaic (PV) panel) within the PV power plant 106 may be designed to harness sunlight and convert it into electricity. Each solar panel may include multiple solar cells made from semiconductor materials, typically silicon, which absorbs photons from sunlight and releases electrons, generating the electric current. Examples of different types of solar panels may include, but are not limited to, a monocrystalline panel, a polycrystalline panel, and a thin-film panel, each with its own efficiency and cost characteristics. For example, the monocrystalline panel may have high efficiency and may be widely used in residential installations, while the thin-film panels may offer versatility and may be often used in utility-scale solar projects due to their lower cost per watt.

In an embodiment, the first fixed bridge 108A may be a connecting structure for the set of solar panels from the first solar panel 106A to the Nth solar panel 106N. In an embodiment, the first fixed bridge 108A may be used to integrate a wiring channel through the first fixed bridge 108A. The integration of the wiring channel with the first fixed bridge 108A may ensure efficient wiring and connection management.

In an embodiment, the first fixed bridge 108A may be equipped with a plurality of mounting points such as the first fixed bridge 108A may be used to equip additional equipment (such as weather sensors, monitoring cameras, environmental sensors, solar thermal collectors, and the like). The first fixed bridge 108A may have an enhanced load-bearing capacity that may support the addition of the additional equipment and may provide enhanced structural support to the set of solar panels of the PV power plant 106. Furthermore, the PV power plant 106 may have one or more fixed bridges (such as the second fixed bridge 108B, up to the Nth fixed bridge 108N). In an embodiment, each of the one or more fixed bridges may be used to connect the set of solar panels.

The server 110 may be a specialized machine that may be designed for a specific task within the network environment 100. The server 110 may play a crucial role in responding to the system 102 request, processing data, and delivering the data efficiently. The server 110 may be designed for high-performance computing and data handling, ensuring that the system 102 requests may be handled accordingly. For example, the server 110 may include but is not limited to, a mail server, a data server, an application server, or a database server.

The docking station 112 may be a central hub where the electronic device 114 (for example robots) may recharge, perform maintenance tasks, and receive updates. The docking station 112 may be equipped with charging ports that may align with the one or more power connectors of the electronic device 114, thereby ensuring efficient energy transfer to recharge one or more batteries of the electronic device 114. The docking station 112 may be designed to accommodate multiple electronic devices (or the robots to clean solar panels) simultaneously, thereby optimizing the cleaning schedule and ensuring that all robots are available for deployment when needed. In an embodiment, the docking station 112 may include diagnostic tools that may monitor the performance and health of the electronic device 114, in addition to charging the electronic device 114. The diagnostic tools may detect issues such as wear and tear on cleaning brushes, battery health, and sensor functionality.

The docking station 112 may also serve as a communication hub, where the electronic devices may upload data collected during cleaning tasks. The data collected during the cleaning tasks may include information associated with the cleanliness of the set of solar panels, detected anomalies associated with the cleanliness of the set of solar panels, and the overall performance of the cleaning tasks. For example, the data associated with cleaning of the set of solar panels may include a percentage of the total area of the set of solar panels cleaned by the electronic device 114, a type of cleaning (if water is used in the cleaning process of the set of solar panels), a type of the brush associated with the electronic device 114 used in the cleaning process, and the like.

Furthermore, the docking station 112 may be designed to be weather-resistant, ensuring that it may operate in various environmental conditions without compromising its desired functionality. The docking station 112 may be equipped with protective covers and drainage systems to prevent water ingress and damage from dust or debris. A robust design may ensure the longevity and reliability of the docking station 112, making it a critical component in the maintenance of PV power plant 106.

The electronic device 114 may include suitable logic, circuitry, interfaces, and/or code that may be configured to perform a set of actions autonomously. The set of actions may include, but are not limited to, navigating the set of solar panels from the first solar panel 106A to the Nth solar panel 106N, cleaning the set of solar panels, and returning back to the docking station 112. The electronic device 114 may be designed to interact with its environment, execute pre-programmed actions, and make real-time decisions based on sensor inputs. The electronic device 114 may be tasked to clean each solar panel of the set of solar panels in the PV power plant 106. Specifically, the electronic device 114 may be a robot that may be configured to clean each solar panel of the set of solar panels in the PV power plant 106. In an embodiment, the electronic device 114 may be a programmable machine designed to perform a specific task autonomously or semi-autonomously. In an embodiment, the electronic device 114 may include a sensor, a power supply, a software, a communication interface, an actuator, and the like. Examples of the electronic device 114 may be, but are not limited to, a track-based robot, a crawler robot, a drone-based robot, a water-based robot, a dry dust removal robot, a modular cleaning robot, an automated scrubber robot, or a vacuum cleaner robot.

The track-based robot may use tracks or wheels to navigate across the surface of the set of solar panels and may be equipped with brushes or scrubbers to clean the set of solar panels. The track-based robot may be efficient for flat or slightly inclined surfaces. The crawler robot may use caterpillar-like tracks for movement on the set of solar panels. Specifically, the crawler robot may be designed for uneven surfaces and may be equipped with cleaning brushes or squeegees. The drone-based robot may be an aerial robot that may be equipped with cleaning mechanisms such as water sprayers or brushes and may be efficient for cleaning hard-to-reach solar panels and large installations. The water-based robot may utilize water tanks and sprayers to clean the set of solar panels. The dry dust removal robot may use air blowers or dry brushes to remove the dust and debris without using water to clean the set of solar panels. The dry dust removal robot may be suitable for arid regions where water may be scarce. The dry dust removal robot may use methods such as air pressure to clean the solar panels. The modular cleaning robot may be equipped with interchangeable cleaning modules and may allow customization for cleaning tasks such as adding brushes, squeegees, vacuum attachments, and the like. The automated scrubber robot may be designed for indoor or flat surface cleaning that may be adaptable for solar panels. The automated scrubber robot may be equipped with rotating brushes and suction mechanisms to clean the solar panels. The vacuum cleaner robot may be used to clean the solar panels that may be located indoors and may use brushes and suction to clean the set of solar panels.

The communication network 116 may include a communication medium through which the system 102, the user device 104, and the PV power plant 106 may communicate with each other. The communication network 116 may be one of a wired connection or a wireless connection. Examples of the communication network 116 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 116 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, institute of electrical and electronics engineers (IEEE) 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

In operation, the dirt and debris may accumulate on the first solar panel 106A, the second solar panel 106B, up to the Nth solar panel 106N over a period of time due to environmental conditions (for example, a sandstorm). The dirt build-up may significantly impact the efficiency and overall performance of the corresponding solar panel in the PV power plant 106. The dirt and debris may be cleaned by a cleaning device (for example, the electronic device 114) associated with the cleaning of the set of solar panels. For the cleaning device to navigate through the set of solar panels, a connecting medium may be required to connect each solar panel of the set of solar panels with each other. Also, the connecting medium may be used as a path for the electronic device 114 to navigate from the first solar panel 106A, the second solar panel 106B, up to the Nth solar panel 106N. The cleaning device may navigate through the set of solar panels through the first fixed bridge 108A, the second fixed bridge 108B, up to the Nth fixed bridge 108N.

In an embodiment, the system 102 may be configured to obtain the user input including the first set of parameters associated with the first fixed bridge 108A from the user device 104. The first fixed bridge 108A may be an inflexible coupling between the first solar panel 106A of a set of solar panels and the second solar panel 106B of the set of solar panels of a photovoltaic (PV) power plant 106. The set of solar panels may be associated with the tracker. The tracker tracks the movement of the sun on one axis. In an embodiment, the first set of parameters may include a first parameter indicative of the gap between the module edge of the first solar panel 106A and the module edge of the second solar panel 106B, a second parameter indicative of a maximum design ground slope of a terrain on which the PV power plant 106 may be installed, a third parameter indicative of a maximum vertical offset of axially adjacent module edges, a fourth parameter indicative of a maximum horizontal offset of the axially adjacent module edges, and a fifth parameter indicative of a maximum magnitude of total angular misalignment between the module edge of the first solar panel 106A and the module edge of the second solar panel 106B. In an embodiment, the axially adjacent module edges are indicative of a first module edge and a second module edge axially adjacent and aligned along a first axis. The first module edge is associated with the first solar panel 106A and the second module edge is associated with the second solar panel 106B.

In an embodiment, the system 102 may be configured to determine the second set of parameters associated with the first fixed bridge 108A based on the first set of parameters. In an embodiment, the system 102 may be configured to render the second set of parameters including the first parameter indicative of the gap between the module edge of the first solar panel 106A and the module edge of the second solar panel 106B, the second parameter indicative of the slope angle across the first fixed bridge 108A, the third parameter indicative of the maximum angular difference between two sides of the first fixed bridge 108A, and the fourth parameter indicative of the width of the flat surface associated with the fail-safe location of the electronic device 114.

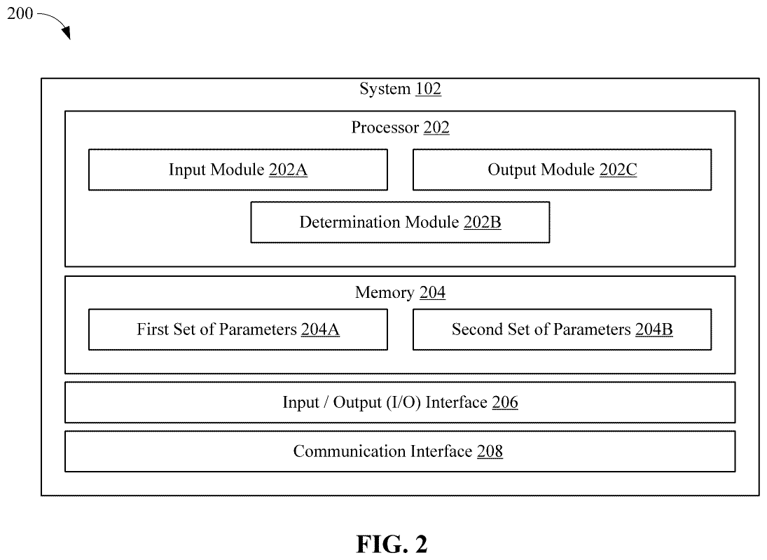

FIG. 2 illustrates a block diagram 200 of the system 102 of FIG. 1, in accordance with an embodiment of the disclosure. FIG. 2 is explained in conjunction with FIG. 1. In FIG. 2, there is shown the block diagram 200 of the system 102. The system 102 may include one or more processors (referred to as a processor 202, hereinafter), a memory 204, an input/output (I/O) interface 206, and a communication interface 208. The processor 202 may be coupled to the memory 204, the I/O interface 206, and the communication interface 208. The processor 202 may include an input module 202A, a determination module 202B, and an output module 202C. The processor 202 may retrieve computer program code instructions that may be stored in the memory 204 for execution of the computer program code instructions. The memory 204 may store data including a first set of parameters 204A, and a second set of parameters 204B. Although in FIG. 2, it is shown that the system 102 includes the processor 202, the memory 204, the I/O interface 206, and the communication interface 208, however, the disclosure may not be so limiting and the system 102 may include fewer or more components to perform the same or other functions of the system 102.

The processor 202 may comprise suitable logic, circuitry, and interfaces that may be configured to execute instructions stored in the memory 204. The executed instructions may correspond to a reception of the user input, the determination of the second set of parameters, and the rendering of the determined second set of parameters. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the communication interface 208 of the system 102. The communication interface 208 may provide an interface for accessing various features and data stored in the system 102.

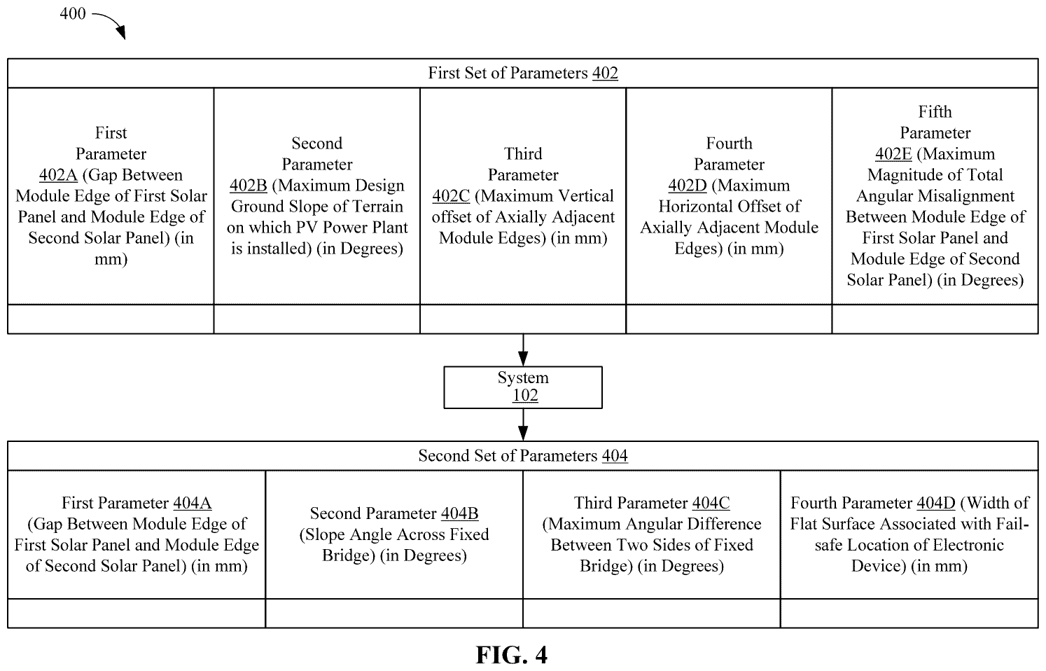

In an embodiment, the input module 202A of the processor 202 may be configured to obtain the user input. The user input may be obtained from the user device 104 and may include the first set of parameters 204A associated with the first fixed bridge 108A. As discussed above, the first fixed bridge 108A, the second fixed bridge 108B, up to the Nth fixed bridge 108N may be used to connect the first solar panel 106A, the second solar panel 106B, up to the Nth solar panel 106N of the set of solar panels. Details about the first set of parameters 204A are provided, for example, in FIG. 4.

The determination module 202B of the processor 202 may be configured to determine the second set of parameters 204B. The second set of parameters 204B may be determined based on the first set of parameters 204A. The second set of parameters 204B may be associated with the first fixed bridge 108A and may include the first parameter indicative of the magnitude of the gap between the module edge of the first solar panel 106A and the module edge of the second solar panel 106B, the second parameter indicative of the magnitude of the slope angle across the first fixed bridge 108A, the third parameter indicative of the magnitude of the maximum angular difference between two sides of the first fixed bridge 108A, and the fourth parameter indicative of the width of the flat surface associated with the fail-safe location of the electronic device 114. For example, the system 102 may determine the second set of parameters 204B associated with the first fixed bridge 108A based on the first set of parameters 204A. Details about the second set of parameters 204B are provided, for example, in FIG. 4.

The output module 202C of the processor 202 may be configured to render the determined second set of parameters 204B. In an embodiment, the output module 202C may be configured to render the second set of parameters on the user device 104. The second set of parameters 204B may include the first parameter indicative of the magnitude of the gap between the module edge of the first solar panel 106A and the module edge of the second solar panel 106B, the second parameter indicative of the magnitude of the slope angle across the first fixed bridge 108A, the third parameter indicative of the magnitude of the maximum angular difference between two sides of the first fixed bridge 108A, and the fourth parameter 404D indicative of the width of the flat surface associated with the fail-safe location of the electronic device 114. For example, the system 102 may render the determined second set of parameters 204B on a user interface (UI) of the user device 104.

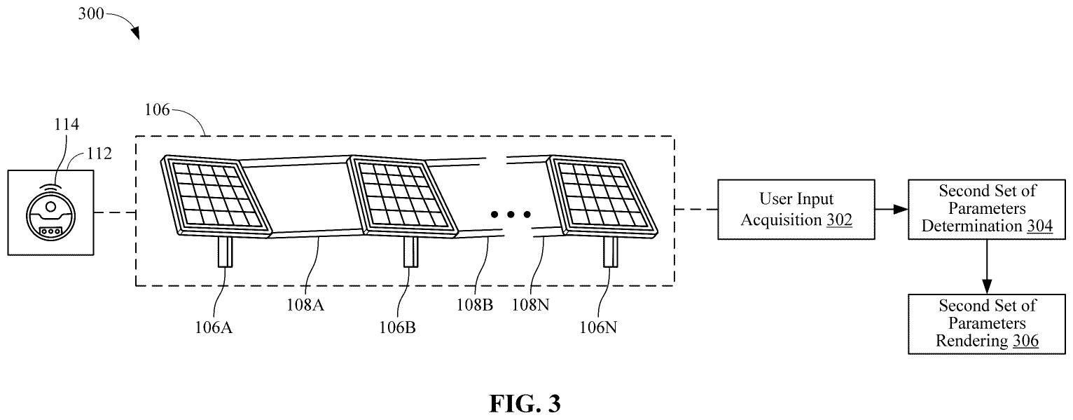

In an embodiment, the second set of parameters 204B may be rendered to determine a set of instructions for the installation of the first fixed bridge 108A based on the second set of parameters 204B. The set of instructions may be associated with the installation of the first fixed bridge 108A. The set of instructions may be further transmitted to an installation device. Details about the installation device and the set of instructions are provided, for example, at 306 in FIG. 3.

In an alternate embodiment, the second set of parameters 204B may be rendered to determine a set of navigation instructions for the electronic device 114 based on the second set of parameters 204B. The set of navigation instructions may be associated with the navigation of the electronic device 114 for cleaning the set of solar panels of the PV power plant. The set of navigation instructions may be transmitted to the electronic device 114. The system 102 may control the electronic device 114 based on the set of navigation instructions. Details about the set of navigation instructions and the electronic device 114 are provided, for example, in FIG. 1.

The memory 204 may include suitable logic, circuitry, and/or interfaces that may be configured to store the program instructions executable by the processor 202. The memory 204 may store the received first set of parameters 204A and the determined second set of parameters 204B. The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

The I/O interface 206 may comprise suitable logic, circuitry, and/or interfaces that may be configured to act as an I/O channel/interface between the user 118 and the system 102. The I/O interface 206 may be configured to receive the user input. In some embodiments, the I/O interface 206 may be configured to render the second set of parameters 204B. The I/O interface 206 may comprise various input and output devices, which may be configured to communicate with different operational components of the system 102. Examples of the I/O interface 206 may include, but are not limited to, a touch screen, a keyboard, a mouse, a joystick, a microphone, and a display screen.

The communication interface 208 may comprise input interface and output interface for supporting communications to and from the system 102, the user device 104, or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

FIG. 3 illustrates exemplary operations for the determination of parameters for the set up of fixed bridges for PV power plants, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 306, as described herein. The exemplary operations illustrated in the block diagram 300 may start at 302 and may be performed by any computing system, apparatus, or device, such as by the system 102 of FIG. 1. Although illustrated with discrete blocks, the exemplary operations associated with one or more blocks of the block diagram 300 may be divided into additional blocks, combined into fewer blocks, or skipped, depending on the implementation.

At 302, a user input acquisition operation may be executed. In the user input acquisition operation, the system 102 may be configured to obtain the user input from the user device 104. The user input may include the first set of parameters 204A associated with the first fixed bridge 108A. The first set of parameters 204A may include the first parameter indicative of the gap between the module edge of the first solar panel 106A and the module edge of the second solar panel 106B, the second parameter indicative of the maximum design ground slope of the terrain on which the PV power plant 106 is installed, the third parameter indicative of the maximum vertical offset of axially adjacent module edges, the fourth parameter indicative of the maximum horizontal offset of the axially adjacent module edges, and the fifth parameter indicative of the maximum magnitude of total angular misalignment between the module edge of the first solar panel 106A and the module edge of the second solar panel 106B. The axially adjacent module edges are indicative of the first module edge and the second module edge axially adjacent and aligned along the first axis. The first module edge is associated with the first solar panel 106A and the second module edge is associated with the second solar panel 106B. In an embodiment, the user input may be obtained from measurement sensors (such as light detection and ranging (LIDAR) sensors, inertial measurement unit (IMU) sensors, and the like) associated with the user device 104. Details about the first set of parameters 204A are provided, for example, in FIG. 4.

At 304, a second set of parameters determination operation may be executed. In the second set of parameters determination operation, the system 102 may be configured to determine the second set of parameters 204B based on the first set of parameters 204A. The second set of parameters 204B may be associated with the first fixed bridge 108A. In an embodiment, the second set of parameters 204B may be determined using an application of one or more mathematical operations on the first set of parameters 204A. In an embodiment, the one or more mathematical operations may include operations such as an addition operation, a subtraction operation, a multiplication operation, a division operation, and the like.

At 306, a second set of parameters rendering operation may be executed. In the second set of parameters rendering operation, the system 102 may be configured to render the second set of parameters 204B. The second set of parameters 204B may include the first parameter indicative of the magnitude of the gap between the module edge of the first solar panel 106A and the module edge of the second solar panel 106B, the second parameter indicative of the magnitude of the slope angle across the first fixed bridge 108A, the third parameter indicative of the magnitude of the maximum angular difference between two sides of the first fixed bridge 108A, and the fourth parameter indicative of the width of the flat surface associated with the fail-safe location of the electronic device 114. In an embodiment, the module edge of the first solar panel 106A may be the outer edge of the first solar panel 106A, and the module edge of the second solar panel 106B may be the outer edge of the second solar panel 106B. The outer edge of the first solar panel 106A may be a peripheral edge of the first solar panel 106A. For example, the outer edge of the first solar panel 106A may be the peripheral edge of the first solar panel 106A that is present between the top right corner of the first solar panel 106A and the bottom right corner of the first solar panel 106A. Similarly, in an example, the outer edge of the second solar panel 106B may be the peripheral edge of the second solar panel 106B that is present between the top left corner of the second solar panel 106B and the bottom left corner of the second solar panel 106B. The design slope across the first fixed bridge 108A may be an angle of the first fixed bridge 108A with respect to the horizontal plane of the ground. The axially adjacent module edges are indicative of the first module edge and the second module edge axially adjacent and aligned along the first axis. The first module edge is associated with the first solar panel 106A and the second module edge is associated with the second solar panel 106B. The fail-safe location of the electronic device 114 may be indicative of a safe location on the first fixed bridge 108A, such that the electronic device 114 may be unharmed in case the electronic device 114 falls from the first fixed bridge 108A.

In an embodiment, the system 102 may be configured to determine a set of instructions for installation of the first fixed bridge 108A based on the second set of parameters 204B. The set of instructions may be associated with the installation of the first fixed bridge 108A. Specifically, the set of instructions may correspond to a set of commands that may be processed by the system 102 for a specific task (for example installation of the first fixed bridge 108A). The set of instructions may include for example an angle of installation of the first fixed bridge 108A with respect to the ground level, a medium of connection between the first solar panel 106A and the second solar panel 106B by the first fixed bridge 108A (such as connecting the first solar panel 106A and the second solar panel 106B by welding, screws, and the like), and the like. In an embodiment, the system 102 may be configured to transmit the set of instructions to an installation device. In an embodiment, the installation device may be a tool, equipment, or an apparatus that may be designed for the installation of a specific system (for example, the installation device may be designed for the installation of the first fixed bridge 108A). For example, the installation device may be used to install the first fixed bridge 108A based on the second set of parameters 204B.

The installation device may be a laser alignment tool, a digital protractor, a mounting template, and the like. The laser alignment tool may use lasers to project horizontal or vertical laser lines across installation areas to precisely align the first fixed bridge 108A. The laser alignment tool may use the lasers to measure distances to ensure efficient placement and alignment of the first fixed bridge 108A. For example, the first fixed bridge 108A may be installed using the laser alignment tool. The laser alignment tool may be placed at the outer module edge of the first solar panel 106A and the outer module edge of the second solar panel 106B. The first fixed bridge 108A may be installed between the module edge of the first solar panel 106A and the module edge of the second solar panel 106B of the set of solar panels. The laser alignment tool may use lasers to align the first fixed bridge 108A with the first solar panel 106A and the second solar panel 106B. The accurate installation of the first fixed bridge 108A aligned with the set of solar panels may ensure a straight and symmetric connection between the solar panels of the set of solar panels. In an embodiment, the first fixed bridge 108A may provide a pathway for the electronic device 114 to clean the set of solar panels.

The digital protractor may provide precise angle measurements to ensure the first fixed bridge 108A may be mounted at a specific angle. The digital protractor may set precise angles for accurate positioning of the first fixed bridge 108A. For example, the angle of installation of the first fixed bridge 108A may be determined as 43.2 degrees anticlockwise from the ground level. In that case, the digital protractor may be used to install the first fixed bridge 108A at the specified angle. The digital protractor may determine the precise angle for the precise installation of the first fixed bridge 108A with a ‘0.1-degree’ accuracy. The mounting template may be a pre-marked template that may help to position the mounting hardware accurately based on a pre-determined set of measurement values (such as the first set of parameters 204A). The mounting hardware may be associated with the first fixed bridge 108A. For example, the mounting template for the first fixed bridge 108A may be used to install the first fixed bridge 108A. The mounting template may be made based on the first set of parameters 204A associated with the first fixed bridge 108A and may be a steel frame on which the first fixed bridge 108A may be directly installed. The steel frame may be specifically designed for the first fixed bridge 108A (such as the point of installation on the steel frame may be designed as per the determined angle of installation of the first fixed bridge 108A).

In an embodiment, the system 102 may be configured to determine the set of navigation instructions for the electronic device 114 based on the second set of parameters 204B. The set of navigation instructions may be associated with the navigation of the electronic device 114 for cleaning the set of solar panels of the PV power plant 106. In an embodiment, the system 102 may be configured to transmit the set of navigation instructions to the electronic device 114. The system 102 may be further configured to control the electronic device 114 based on the set of navigation instructions. The set of navigation instructions may include instructions for the electronic device 114 to maintain a pre-defined speed while navigating through the first fixed bridge 108A, instructions for the electronic device 114 to clean the first fixed bridge 108A while navigating through the first fixed bridge 108A to ensure a smooth navigation, instructions for the electronic device 114 to return to the docking station 112 associated with the PV power plant 106, instructions for the electronic device 114 to leave the docking station 112, instructions for the electronic device 114 to retry navigation in case the electronic device 114 cannot find the docking station 112, instructions for the electronic device 114 to clean the set of solar panels and dock back at the docking station 112 by navigating through the first fixed bridge 108A, instructions for the electronic device 114 to clean the set of solar panels multiple times (for example, the electronic device 114 may clean the set of solar panels 3 times back and forth), instructions for the electronic device 114 to start cleaning the set of solar panels from the solar panel adjacent to the docking station 112, instructions for the electronic device 114 to start cleaning the set of solar panels at the extreme end opposite to the solar panel adjacent to the docking station 112 and end the cleaning at the solar panel adjacent to the docking station 112 (for example, a dirt collector may be installed at the edge of the solar panel adjacent to the docking station 112 that may collected the dirt and debris cleaned from the set of solar panels), and the like.

FIG. 4 is a diagram that illustrates a first set of parameters 402 and a second set of parameters 404, in accordance with an embodiment of the disclosure. FIG. 4 is explained in conjunction with elements from FIG. 1, FIG. 2, and FIG. 3. With reference to FIG. 4, there is shown a block diagram 400. There is further shown the first set of parameters 402 and the second set of parameters 404. The first set of parameters 402 may be indicative of the user input obtained from the user device 104 associated with the first fixed bridge 108A. With reference to FIG. 4, there is further shown the system 102. The system 102 may be configured to render the second set of parameters 404 associated with the first fixed bridge 108A based on the received first set of parameters 402. The first set of parameters 402 is an exemplary embodiment of the first set of parameters 204A of FIG. 2. Similarly, the second set of parameters 404 is an exemplary embodiment of the second set of parameters 204B of FIG. 2.

As previously discussed, the set of solar panels (the first solar panel 106A, the second solar panel 106B, up to the Nth solar panel 106N) may be PV devices that may generate electricity from the sunlight. In an embodiment, the electronic device 114 may be used to clean the set of solar panels as they may access difficult-to-reach areas and may provide an accessible and economical implementation. Further, after the cleaning of the set of solar panels, optimal absorption of sunlight may be ensured, thereby amplifying energy production and reducing maintenance costs.

However, for the electronic device 114 to navigate from the first solar panel 106A, the second solar panel 106B, up to the Nth solar panel 106N of the set of solar panels, the incorporation of connecting structure between each solar panel of the set of solar panels may be required. The connecting structure may be used to connect two solar panels (for example, the first solar panel 106A and the second solar panel 106B) of the set of solar panels. The connecting structure of each solar panel of the set of solar panels may be a specialized connection such as a bridge. In an embodiment, the first solar panel 106A, the second solar panel 106B, up to the Nth solar panel 106N of the set of solar panels may be connected by the first fixed bridge 108A, the second fixed bridge 108B, up to the Nth fixed bridge 108N. The set of solar panels may be associated with the tracker. The tracker tracks the movement of the sun on one axis. For example, the first fixed bridge 108A may be the connection between the first solar panel 106A and the second solar panel 106B.

Further, in order to determine an efficient and effective connecting structure between the set of solar panels, the system 102 may determine the second set of parameters 404 associated with the first fixed bridge 108A based on the first set of parameters 402. The first fixed bridge 108A may connect the first solar panel 106A and the second solar panel 106B. The first set of parameters 402 and the second set of parameters 404 may be associated with the first fixed bridge 108A.

In an embodiment, the first set of parameters 402 may include a first parameter 402A indicative of the gap between the module edge of the first solar panel 106A and the module edge of the second solar panel 106B. The module edge of the first solar panel 106A may be adjacent to the module edge of the second solar panel 106B. The gap between the module edge of the first solar panel 106A and the module edge of the second solar panel 106B may be indicative of a perpendicular distance between the first solar panel 106A and the second solar panel 106B of the set of solar panels for which the first fixed bridge 108A may be mounted. In an embodiment, the first parameter 402A may be measured in millimeters. For example, the first parameter 402A is ‘500’ millimeters indicative of the perpendicular distance between the module edge of the first solar panel 106A and the module edge of the second solar panel 106B.

In an embodiment, a higher value of the first parameter 402A (as compared to a pre-determined standard value) may lead to a bigger footprint of the PV power plant 106. The bigger footprint of the PV power plant 106 may be indicative of higher land costs that may lead to higher project costs (as compared to the cost associated with the pre-determined standard value). In case of a smaller value of the first parameter 402A (as compared to the pre-determined standard value), the efficiency of the electronic device 114 to traverse along the set of solar panels may decrease as compared to the efficiency of the electronic device 114 associated with the pre-determined standard value of the first parameter 402A.

In an embodiment, the first set of parameters 402 may include a second parameter 402B indicative of the maximum design ground slope of the terrain on which the PV power plant 106 may be installed. The maximum design ground slope may be indicative of the steepest allowable slope or an inclination of the ground or terrain on which the PV power plant 106 may be built. In an embodiment, the second parameter 402B may be measured in degrees. For example, the second parameter 402B is ‘30’ degrees anticlockwise to the horizontal level indicative of the inclination of the terrain on which the PV power plant 106 may be built. In an embodiment, the second parameter 402B may be typically a land-associated value that may only be changed to a small extent as it may be directly linked with the cost of operation of the PV power plant 106.

In an embodiment, the first set of parameters 402 may include a third parameter 402C indicative of the maximum vertical offset of axially adjacent module edges. The maximum vertical offset of axially adjacent module edges may include a maximum vertical installation tolerance of a fixed tilt structure. The fixed tilt structure may be a structure on which the set of solar panels may be installed. The set of solar panels may be associated with the tracker. The tracker tracks the movement of the sun on one axis. For example, the fixed tilt structure may be a steel structure tilted at an angle of ‘45’ degrees from the horizontal level on which the set of solar panels may be installed. In an example, the third parameter 402C may be obtained from a construction contractor who may be responsible for the construction of the PV power plant 106.

The maximum vertical offset of the axially adjacent module edges may be indicative of the maximum permissible vertical displacement between the axially adjacent module edges. The axially adjacent module edges may be indicative of a first module edge and a second module edge axially adjacent and aligned along a first axis. The first module edge is associated with the first solar panel 106A and the second module edge is associated with the second solar panel 106B. In an embodiment, the third parameter 402C may be measured in millimeters. For example, the third parameter 402C is ‘450’ millimeters indicative of the maximum vertical offset of the first module edge and the second module edge.

In an embodiment, the first set of parameters 402 may include a fourth parameter 402D indicative of the maximum horizontal offset of the axially adjacent module edges. The maximum horizontal offset of the axially adjacent module edges may include a maximum horizontal installation tolerance of the fixed tilt structure. The maximum horizontal offset of the axially adjacent module edges may be indicative of the maximum permissible horizontal displacement between the axially adjacent module edges. In an embodiment, the fourth parameter 402D may be measured in millimeters. For example, the fourth parameter 402D is ‘600’ millimeters indicative of the maximum horizontal offset of the first module edge and the second module edge. In an example, the fourth parameter 402D may be obtained from a construction contractor who may be responsible for the construction of the PV power plant 106.

In an embodiment, the first set of parameters 402 may include a fifth parameter 402E indicative of the maximum magnitude of total angular misalignment between the module edge of the first solar panel 106A and the module edge of the second solar panel 106B. The total angular misalignment between the module edge of the first solar panel 106A and the module edge of the second solar panel 106B may be indicative of an angular difference in orientation between the first solar panel 106A and the second solar panel 106B. In an embodiment, the total angular misalignment between the module edge of the first solar panel 106A and the module edge of the second solar panel 106B may be a measure of how much a solar panel (such as the first solar panel 106A) or a solar array may deviate from an optimal alignment with respect to an adjacent panel (such as the second solar panel 106B). In an embodiment, the fifth parameter 402E may be measured in degrees. For example, the fifth parameter 402E is ‘50’ degrees anticlockwise to the horizontal level indicative of the angular misalignment between the module edge of the first solar panel 106A and the module edge of the second solar panel 106B.

Based on the first set of parameters 402, the system 102 may be configured to determine the second set of parameters 404. The first set of parameters 402 and the second set of parameters 404 may be associated with the first fixed bridge 108A.

In an embodiment, the second set of parameters 404 may include a first parameter 404A indicative of the gap between the module edge of the first solar panel 106A and the module edge of the second solar panel 106B. The module edge of the first solar panel 106A may be adjacent to the module edge of the second solar panel 106B. The gap between the module edge of the first solar panel 106A and the module edge of the second solar panel 106B may be indicative of a perpendicular distance between the first solar panel 106A and the second solar panel 106B of the set of solar panels for which the first fixed bridge 108A may be mounted. In an embodiment, the system 102 may be configured to determine a proposed value for the gap between the module edge of the first solar panel 106A and the module edge of the second solar panel 106B based on the first parameter 402A of the first set of parameters 402. In an embodiment, the first parameter 402A may be measured in millimeters. For example, the first parameter 402A is ‘700’ millimeters indicative of the perpendicular distance between the module edge of the first solar panel 106A and the module edge of the second solar panel 106B.

In an embodiment, a higher value of the first parameter 404A (as compared to the pre-determined standard value) may lead to a bigger footprint of the PV power plant 106. The bigger footprint of the PV power plant 106 may be indicative of higher land costs that may lead to higher project costs (as compared to the cost associated with the pre-determined standard value). In case of a smaller value of the first parameter 404A (as compared to the pre-determined standard value), the efficiency of the electronic device 114 to traverse along the set of solar panels may decrease as compared to the efficiency of the electronic device 114 associated with the pre-determined standard value of the first parameter 404A.

In an embodiment, the second set of parameters 404 may include a second parameter 404B indicative of the slope angle across the first fixed bridge 108A. The slope angle across the first fixed bridge 108A may be indicative of an angle at which the surface of the first fixed bridge 108A may be positioned relative to a horizontal plane. In an embodiment, a tilt of the set of solar panels may be determined by the angle across the first fixed bridge 108A. The tilt of the set of solar panels may be designed to optimize the exposure of the set of solar panels to the sunlight to maximize the captured sunlight for the set of solar panels. The set of solar panels may be associated with the tracker. The tracker tracks the movement of the sun on one axis. In an embodiment, the second parameter may be measured in degrees. For example, the second parameter 404B is ‘45’ degrees clockwise from horizontal or ground level indicative of the slope angle across the first fixed bridge relative to the horizontal plane. In an embodiment, the second parameter 404B may be determined using the first parameter 402A and the third parameter 402C. In an embodiment, the second parameter 404B may be obtained from a supplier of the electronic device 114. The robot supplier may design a motor for the electronic device 114 based on the slope angle across the first fixed bridge 108A. In an embodiment, the second parameter 404B may be determined using the first parameter 402A and the third parameter 402C.

In an embodiment, the second set of parameters 404 may include a third parameter 404C indicative of the maximum angular difference between two sides of the first fixed bridge 108A. The maximum angular difference between the two sides of the first fixed bridge 108A may be indicative of a maximum allowable variance between the two edges of the first fixed bridge 108A. The maximum allowable variance between the two sides of the first fixed bridge 108A may be a measure of how much the first side of the first fixed bridge 108A may be inclined relative to a second side of the first fixed bridge 108A. The first side of the first fixed bridge 108A associated with the first solar panel 106A may be directly connected to the first solar panel 106A by one of the screws, welds, bolts, rivets, and the like. Similarly, the second side of the first fixed bridge associated with the second solar panel 106B may be directly connected to the second solar panel 106B by one of the screws, welds, bolts, rivets, and the like. In an embodiment, the third parameter 404C may be determined using the first parameter 402A and the third parameter 402C. In an embodiment, the third parameter 404C may be measured in degrees. For example, the third parameter 404C is ‘15’ degrees indicative of the angular difference between the first side of the first fixed bridge 108A directly connected with the first solar panel 106A and the second side of the first fixed bridge 108A directly connected with the second solar panel 106B. In an embodiment, the third parameter 404C may be determined using the first parameter 402A, the third parameter 402C, and the fourth parameter 402D. In an embodiment, the third parameter 404C may be obtained from the supplier of the electronic device 114.

In an embodiment, the second set of parameters 404 may include a fourth parameter 404D indicative of the width of the flat surface associated with the fail-safe location of the electronic device 114. The flat surface may be a two-dimensional structure that is perfect even without any curves. The flat surface may be associated with the fail-safe location first fixed bridge 108A. The fail-safe location of the electronic device 114 may be indicative of the safe location on the first fixed bridge 108A, such that the electronic device 114 may be unharmed in case the electronic device 114 falls from the first fixed bridge 108A. In an embodiment, the width of the first fixed bridge 108A may be determined. The width of the first fixed bridge 108A may be a perpendicular distance measured horizontally across the first fixed bridge 108A. Further, the width of the electronic device 114 may be determined. The width of the electronic device 114 may be a perpendicular distance measured horizontally across the electronic device 114. Further, sum operation may be applied on the width of the electronic device 114 and a pre-determined numerical value. Furthermore, the greater value between the width of the first fixed bridge 108A and the combined width of the electronic device 114 and the pre-determined numerical value may be utilized as the width of the flat surface associated with the fail-safe location of the electronic device 114. For example, the width of the first fixed bridge 108A may be ‘800’ millimeters, the width of the electronic device 114 may be ‘500’ millimeters, and the pre-determined numerical value may be ‘200’ millimeters. Therefore, the combined width of the electronic device 114 and the pre-determined numerical value may be ‘700’ millimeters. In this case, the width of the flat surface associated with the fail-safe location of the electronic device 114 may be the value associated with the width of the first fixed bridge 108A corresponding to ‘800’ millimeters.

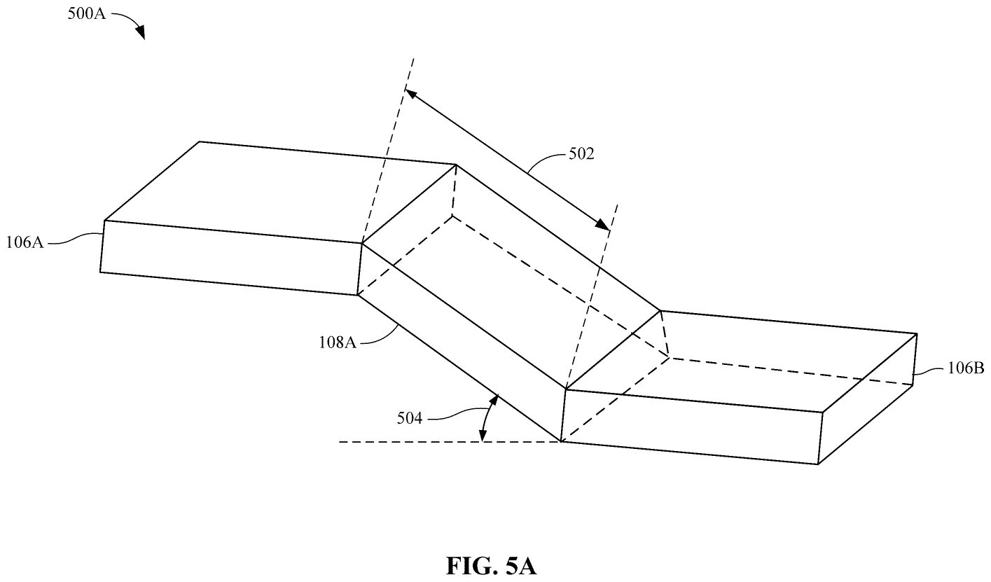

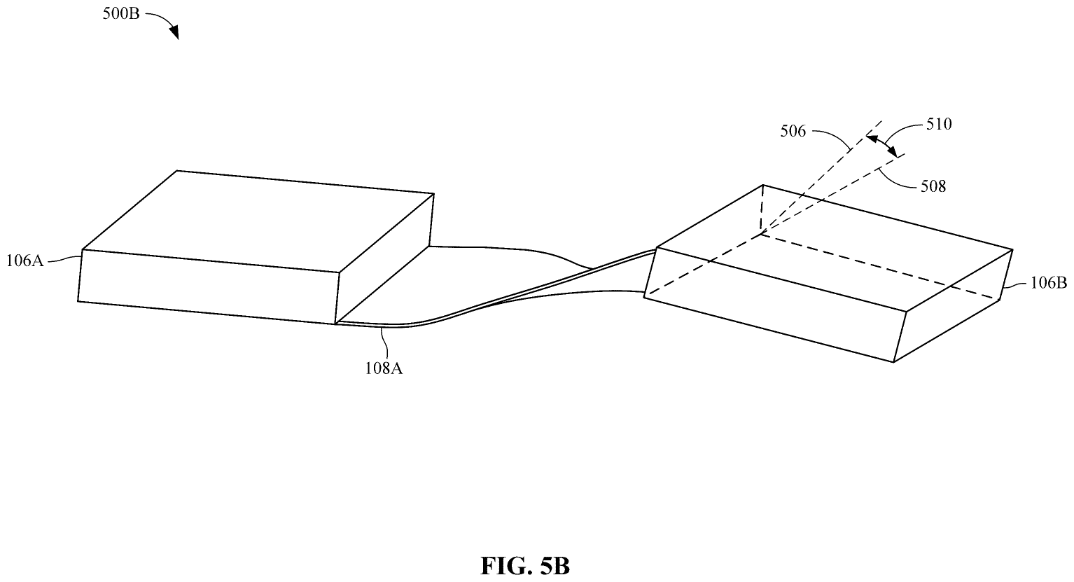

FIGS. 5A and 5B are exemplary diagrams 500A and 500B respectively that collectively depict the second set of parameters 204B associated with the first fixed bridge 108A, in accordance with an embodiment of the disclosure. FIGS. 5A and 5B are explained in conjunction with FIG. 1, FIG. 2, FIG. 3 and FIG. 4.

In an embodiment, the system 102 may be configured to determine the second set of parameters 204B based on the first set of parameters 204A. The second set of parameters 204B may be associated with the first fixed bridge 108A. The second set of parameters 204B may include a first portion 502 indicative of the gap between the module edge of the first solar panel 106A and the module edge of the second solar panel 106B, a second portion 504 indicative of the slope angle across the first fixed bridge 108A, and a third portion 510 indicative of the maximum angular difference between the two sides of the first fixed bridge 108A. The first portion 502 is indicative of the first parameter 404A of FIG. 4. The second portion 504 is indicative of the second parameter 404B of FIG. 4. The third portion 510 is indicative of the third parameter 404C of FIG. 4.

In an embodiment, the first portion 502 may be indicative of the gap between the module edge of the first solar panel 106A and the module edge of the second solar panel 106B. In an embodiment, the system 102 may be configured to determine the proposed value for the gap between the module edge of the first solar panel 106A and the module edge of the second solar panel 106B. For example, the first portion 502 may be measured in millimeters. For example, the first portion 502 is ‘150 millimeters’ indicative of the perpendicular gap (perpendicular distance) between the module edge of the first solar panel 106A and the module edge of the second solar panel 106B is ‘150 millimeters’. In an embodiment, the first portion 502 may be used to determine the length of the first fixed bridge 108A.

In an embodiment, the second portion 504 may be indicative of the design slope angle across the first fixed bridge 108A. In an embodiment, the system 102 may be configured to determine the proposed value for the design slope angle across the first fixed bridge 108A. The design slope across the first fixed bridge 108A may be an angle of the first fixed bridge 108A with respect to the horizontal plane. For example, the second portion 504 may be measured in degrees. For example, the second portion 504 is ‘45’ degrees clockwise from horizontal or ground level indicative of the design slope angle across the first fixed bridge 108A.

In an embodiment, the third portion 510 may be the maximum angular difference between the two sides of the first fixed bridge 108A. In an embodiment, an angle across the side of the first fixed bridge 108A associated with the first solar panel 106A may be represented by 508. In another embodiment, the angle across the side of the first fixed bridge 108A associated with the second solar panel 106B may be represented by 506. In an embodiment, the angle between the two sides of the first fixed bridge 108A (angle between 506 and 508) may be represented by 510 indicative of the maximum angular difference between the two sides of the first fixed bridge 108A. For example, the third portion 510 may be measured in degrees. For example, the third portion 510 is ‘150’ degrees anticlockwise indicative of the angle between the two sides of the first fixed bridge 108A.

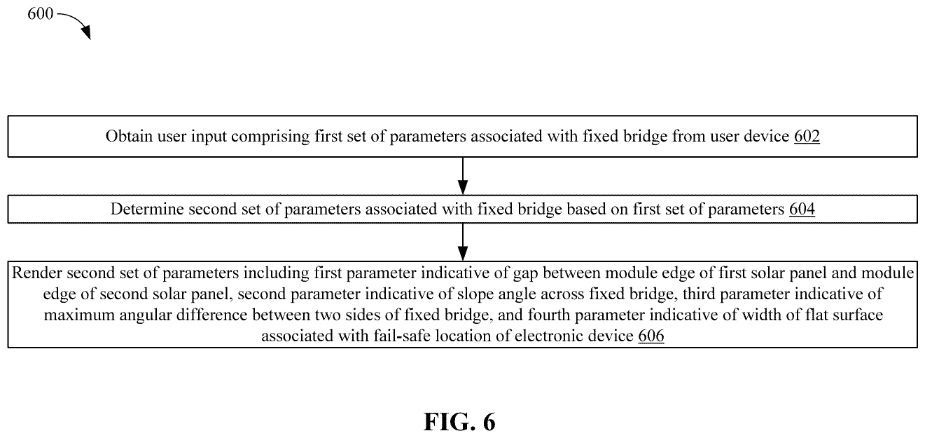

FIG. 6 illustrates a method flowchart for the determination of parameters for the set up of fixed bridges for PV power plants, in accordance with an embodiment of the disclosure. FIG. 6 is explained in conjunction with elements of FIG. 1, FIG. 2, FIG. 3, FIG. 4, FIG. 5A, and FIG. 5B. With reference to FIG. 6, there is shown a flowchart 600. The operations of the exemplary method may be executed by any computing system, for example, by the system 102 of FIG. 1 or the processor 202 of FIG. 2. The operations of the flowchart 600 may start at 602.

At 602, the user input including the first set of parameters 204A associated with the first fixed bridge 108A may be obtained from the user device 104. In an embodiment, the system 102 may be configured to obtain the user input including the first set of parameters 204A associated with the first fixed bridge 108A from the user device 104. In at least one embodiment, the processor 202 may be configured to obtain the user input including the first set of parameters 204A associated with the first fixed bridge 108A from the user device 104. Details about obtaining the user input are provided, for example, in FIG. 3.

At 604, the second set of parameters 204B associated with the first fixed bridge 108A may be determined based on the first set of parameters 204A. In an embodiment, the system 102 may be configured to determine the second set of parameters 204B associated with the first fixed bridge 108A based on the first set of parameters 204A. In at least one embodiment, the processor 202 may be configured to determine the second set of parameters 204B associated with the first fixed bridge 108A based on the first set of parameters 204A. Details about the determination of the second set of parameters 204B are provided, for example, in FIG. 3 and FIG. 4.

At 606, the determined second set of parameters 204B may be rendered. In an embodiment, the system 102 may be configured to render the determined second set of parameters 204B including the first parameter 404A indicative of the gap between the module edge of the first solar panel 106A and the module edge of the second solar panel 106B, the second parameter 404B indicative of the slope angle across the first fixed bridge 108A, the third parameter 404C indicative of the maximum angular difference between two sides of the first fixed bridge 108A, and the fourth parameter 404D indicative of the width of the flat surface associated with the fail-safe location of the electronic device 114. In at least one embodiment, the processor 202 may be configured to render the determined second set of parameters 204B. Details about the rendering of the second set of parameters 204B are provided, for example, in FIG. 3.

Further, the operations of the method flowchart 600 are performed, but not limited to, the first fixed bridge 108A. The operations of the method flowchart 600 may be performed for the set up of the second fixed bridge 108B, up to the Nth fixed bridge 108N.

Accordingly, blocks of the method flowchart 600 support combinations of means for performing the specified functions and combinations of operations for performing the specified functions. It will also be understood that one or more blocks of the method flowchart 600, and combinations of blocks in the method flowchart 600, can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system comprising:
processor configured to:
obtain, from a user device, a user input comprising a first set of parameters associated with a fixed bridge, wherein the fixed bridge is an inflexible coupling between a first solar panel of a set of solar panels and a second solar panel of the set of solar panels of a photovoltaic (PV) power plant, and wherein the set of solar panels is associated with a tracker;
determine a second set of parameters associated with the fixed bridge based on the first set of parameters; and
render the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

2. The system of claim 1, wherein the processor is configured to:
determine a set of instructions for installation of the fixed bridge based on the second set of parameters, wherein the set of instructions is associated with the installation of the fixed bridge between the first solar panel and the second solar panel; and
transmit the set of instructions to an installation device.

3. The system of claim 1, wherein the processor is configured to:
determine a set of navigation instructions for the electronic device based on the second set of parameters, wherein the set of navigation instructions is associated with cleaning of the set of solar panels of the PV power plant;
transmit the set of navigation instructions to the electronic device; and
control the electronic device based on the set of navigation instructions.

4. The system of claim 3, wherein the set of navigation instructions comprises a first navigation instruction to control the electronic device to navigate through the fixed bridge.

5. The system of claim 3, wherein the electronic device comprises at least one of a track-based robot, a crawler robot, a drone-based robot, a water-based robot, a dry dust removal robot, a modular cleaning robot, an automated scrubber robot, or a vacuum cleaner robot.

6. The system of claim 1, wherein the second set of parameters is determined using an application of one or more mathematical operations on the first set of parameters.

7. The system of claim 1, wherein the first set of parameters comprises of a first parameter indicative of the gap between the module edge of the first solar panel and the module edge of the second solar panel, a second parameter indicative of a maximum design ground slope of a terrain on which the PV power plant is installed, a third parameter indicative of a maximum vertical offset of axially adjacent module edges, a fourth parameter indicative of a maximum horizontal offset of the axially adjacent module edges, and a fifth parameter indicative of a maximum magnitude of total angular misalignment between the module edge of the first solar panel and the module edge of the second solar panel.

8. The system of claim 7, wherein the axially adjacent module edges are indicative of a first module edge and a second module edge axially adjacent and aligned along a first axis, and wherein the first module edge is associated with the first solar panel and the second module edge is associated with the second solar panel.

9. A method comprising:
obtaining, from a user device, user input comprising a first set of parameters associated with a fixed bridge, wherein the fixed bridge is an inflexible coupling between a first solar panel of a set of solar panels and a second solar panel of the set of solar panels of a photovoltaic (PV) power plant, and wherein the set of solar panels is associated with a tracker;
determining a second set of parameters associated with the fixed bridge based on the first set of parameters; and
rendering the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

10. The method of claim 9, further comprising:
determining a set of instructions for installation of the fixed bridge based on the second set of parameters, wherein the set of instructions is associated with the installation of the fixed bridge between the first solar panel and the second solar panel; and
transmitting the set of instructions to an installation device.

11. The method of claim 9, further comprising:
determining a set of navigation instructions for the electronic device based on the second set of parameters, wherein the set of navigation instructions is associated with cleaning of the set of solar panels of the PV power plant;
transmitting the set of navigation instructions to the electronic device; and
controlling the electronic device based on the set of navigation instructions.

12. The method of claim 11, wherein the set of navigation instructions comprises a first navigation instruction to control the electronic device to navigate through the fixed bridge.

13. The method of claim 11, wherein the electronic device comprises at least one of a track-based robot, a crawler robot, a drone-based robot, a water-based robot, a dry dust removal robot, a modular cleaning robot, an automated scrubber robot, or a vacuum cleaner robot.

14. The method of claim 9, wherein the second set of parameters is determined using an application of one or more mathematical operations on the first set of parameters.

15. The method of claim 9, wherein the first set of parameters comprises of a first parameter indicative of the gap between the module edge of the first solar panel and the module edge of the second solar panel, a second parameter indicative of a maximum design ground slope of a terrain on which the PV power plant is installed, a third parameter indicative of a maximum vertical offset of axially adjacent module edges, a fourth parameter indicative of a maximum horizontal offset of the axially adjacent module edges, and a fifth parameter indicative of a maximum magnitude of total angular misalignment between the module edge of the first solar panel and the module edge of the second solar panel.

16. The method of claim 15, wherein the axially adjacent module edges are indicative of a first module edge and a second module edge axially adjacent and aligned along a first axis, and wherein the first module edge is associated with the first solar panel and the second module edge is associated with the second solar panel.

17. A computer programmable product comprising a non-transitory computer readable medium having stored thereon computer executable instructions, which when executed by a processor, cause the processor to conduct operations, comprising:
obtaining, from a user device, user input comprising a first set of parameters associated with a fixed bridge, wherein the fixed bridge is an inflexible coupling between a first solar panel of a set of solar panels and a second solar panel of the set of solar panels of a photovoltaic (PV) power plant, and wherein the set of solar panels is associated with a tracker;
determining a second set of parameters associated with the fixed bridge based on the first set of parameters; and
rendering the second set of parameters including a first parameter indicative of a gap between a module edge of the first solar panel and a module edge of the second solar panel, a second parameter indicative of a slope angle across the fixed bridge, a third parameter indicative of a maximum angular difference between two sides of the fixed bridge, and a fourth parameter indicative of the width of a flat surface associated with a fail-safe location of an electronic device.

18. The computer programmable product of claim 17, the operations further comprising:
determining a set of instructions for installation of the fixed bridge based on the second set of parameters, wherein the set of instructions is associated with the installation of the fixed bridge between the first solar panel and the second solar panel; and
transmitting the set of instructions to an installation device.

19. The computer programmable product of claim 17, the operations further comprising:
determining a set of navigation instructions for the electronic device based on the second set of parameters, wherein the set of navigation instructions is associated with cleaning of the set of solar panels of the PV power plant;
transmitting the set of navigation instructions to the electronic device; and
controlling the electronic device based on the set of navigation instructions.

20. The computer programmable product of claim 19, wherein the set of navigation instructions comprises a first navigation instruction to control the electronic device to navigate through the fixed bridge.
